(19) United States
(12) Patent Application Publication
(10) Pub. No.: US 2026/0037196 A1
(43) Pub. Date: Feb. 5, 2026

(54) PRINT IMAGE ADJUSTMENT METHOD

(71) Applicant: SEIKO EPSON CORPORATION, Tokyo (JP)

(72) Inventors: Yusuke WATANABE, AZUMINO-SHI (JP); Shigeru AOKI, SHIOJIRI-SHI (JP)

(21) Appl. No.: 19/289,219

(22) Filed: Aug. 4, 2025

(30) Foreign Application Priority Data
Aug. 5, 2024 (JP) 2024-128840

(51) Int. Cl. G06F 3/12; B41J 2/005; B41J 2/01; B41J 3/407; B41J 3/46; G06K 15/02

(52) U.S. Cl. CPC G06F 3/125; B41J 2/0057; B41J 3/4078; B41J 3/46; G06F 3/1208; G06F 3/1255; G06F 3/1256; G06K 15/1848; B41J 2002/012

(57) ABSTRACT

A print image adjustment method includes a printable range setting step of setting a printable range, an image preparation step of preparing an image, a display step of displaying a position of the printable range and the image, and a print image processing step of processing the image to generate a print image, wherein the print image processing step includes processing the image to fit the print image within the printable range.

The present application is based on, and claims priority from JP Application Serial Number 2024-128840, filed Aug. 5, 2024, the disclosure of which is hereby incorporated by reference herein in its entirety.

### BACKGROUND

### 1. Technical Field

The present disclosure relates to a print image adjustment method.

### 2. Related Art

In the related art, as disclosed in JP-A-2022-43530, there is known an apparatus that compares a printable maximum range with position information of a medium to be printed and notifies a user when determining that printing cannot be performed.

JP-A-2022-43530 is an example of the related art.

However, in the above-described apparatus, when it is notified that printing cannot be performed on the medium, it is necessary for the user to take measures such as changing the position of the medium, changing the size of the image and realigning the image, allowing printing to be performed outside the medium and forcibly performing printing, and convenience is low.

### SUMMARY

A print image adjustment method includes a printable range setting step of setting a printable range, an image preparation step of preparing an image, a display step of displaying a position of the printable range and the image, and a print image processing step of processing the image to generate a print image, wherein the print image processing step includes processing the image to fit the print image within the printable range.

### BRIEF DESCRIPTION OF THE DRAWINGS

FIG. 1 is a block diagram illustrating a configuration of a printing system.

FIG. 2 is a perspective view showing a printing apparatus.

FIG. 3 is a flowchart showing a print image adjustment method for an information processing apparatus to set an image to be printed in the printing apparatus.

FIG. 4 is a schematic diagram showing a platen setting screen.

FIG. 5 is a schematic diagram showing a medium guide setting screen.

FIG. 6 is a schematic diagram showing a screen displaying a medium guide corresponding to a medium and a virtual platen corresponding to a platen.

FIG. 7 is a schematic diagram showing a first screen when a first image is to be set on a first medium guide.

FIG. 8 is a flowchart showing a print image adjustment method when a fit button on the medium guide setting screen is selected.

FIG. 9 is a schematic diagram showing the first screen when the first image is set on the first medium guide.

FIG. 10 is a schematic diagram showing a second screen when the first image is set on a second medium guide in a different alignment from that of the first medium guide.

FIG. 11 is a schematic diagram showing a third screen when a third image larger than a third medium guide is to be set.

FIG. 12 is a schematic diagram showing the third screen when the third image is reduced and set in accordance with the third medium guide.

FIG. 13 is a schematic diagram showing the third screen when the third image is cut and set in accordance with the third medium guide.

FIG. 14 is a schematic diagram showing an image when a first fit image obtained by enlarging the first image in accordance with the virtual platen is set.

FIG. 15 is a flowchart showing a print image adjustment method when a margin is set in the medium guide.

FIG. 16 is a schematic diagram showing a margin setting screen.

FIG. 17 is a schematic diagram showing a fourth screen when the first image is set on the first medium guide at the time of margin setting.

FIG. 18 is a flowchart showing a print image adjustment method when a platen fit button on the platen setting screen is selected.

### DESCRIPTION OF EMBODIMENTS

### 1. Configuration of Printing System

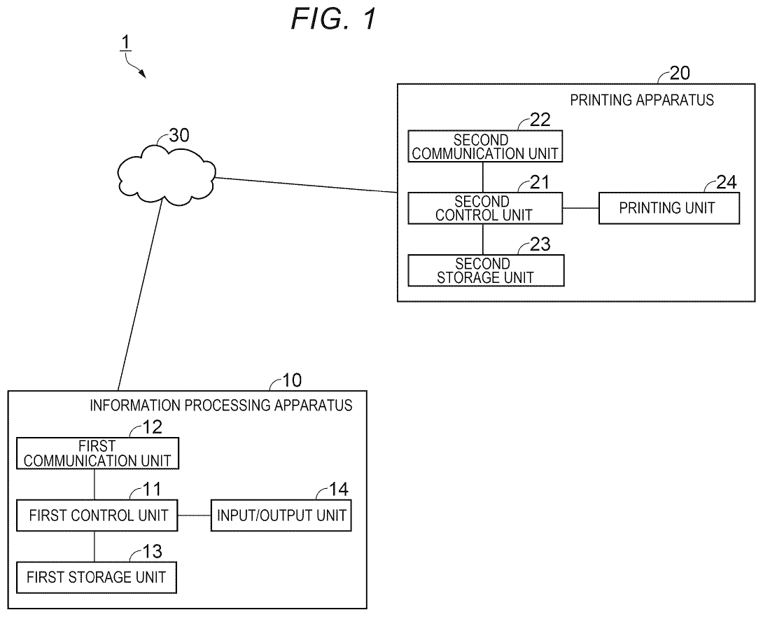

As illustrated in FIG. 1, a printing system 1 includes an information processing apparatus 10 and a printing apparatus 20.

The information processing apparatus 10 and the printing apparatus 20 can communicate with each other via, for example, a WAN (Wide Area Network) 30 as the Internet. Note that the WAN 30 may be a network such as a LAN (Local Area Network).

For example, unique IP addresses (Internet Protocol Addresses) are respectively assigned to the information processing apparatus 10 and the printing apparatus 20. These apparatuses can designate the IP address assigned to the communication destination and communicate with the communication destination.

The information processing apparatus 10 and the printing apparatus 20 may directly communicate with each other by USB (Universal Serial Bus), Bluetooth (registered trademark), or the like not via a network.

The information processing apparatus 10 includes a first control unit 11, a first communication unit 12, and a first storage unit 13.

The first control unit 11 performs integrated control of the respective units of the information processing apparatus 10. The first control unit 11 includes a CPU (Central Processing Unit), a UART (Universal Asynchronous Receiver Transmitter) that manages input and output, and an FPGA (field programmable gate array) and a PLD (Programmable Logic Device), which are logic circuits. The first controller 11 is also referred to as a processor. The CPU of the first controller 11 may be particularly referred to as a processor.

The first storage unit 13 includes memories such as a flash ROM (Read Only Memory) and an HDD (Hard Disk Drive), which are rewritable nonvolatile memories, and a RAM (Random Access Memory), which is a volatile memory.

The CPU of the first control unit 11 reads a program stored in the nonvolatile memory of the first storage unit 13 and executes the program using the RAM of the first storage unit 13 as a work area.

The first storage unit 13 can store a program for executing a print image adjustment method described later, a plurality of images G to be printed, and the like.

The first communication unit 12 includes a circuit that can communicate by radio or wire. The first communication unit 12 includes an antenna for the communication by radio and includes a connector for the communication by wire.

The first communication unit 12 can communicate via the WAN 30. When performing transmission and reception to and from a communication destination, the information processing apparatus 10 uses the first communication unit 12. However, in order to simplify the explanation, the transmission and reception by the first communication unit 12 will be omitted. The same applies to a second communication unit 22 of the printing apparatus 20 described later.

The information processing apparatus 10 further includes an input/output unit 14. The input/output unit 14 is a user interface for a user.

The input/output unit 14 is, for example, a touch panel display. The input/output unit 14 includes a display panel as an output unit that displays various kinds of information, and a detection panel as an input unit.

The detection panel is laid over the display panel. The detection panel can detect operation of a finger or the like of the user using a method such as a capacitive method, a resistive method, or an optical method.

In the input/output unit 14, the input unit may be a keyboard, a mouse, buttons, or the like and the output unit may be a stand-type liquid crystal display or the like.

The printing apparatus 20 includes a second control unit 21, the second communication unit 22, and a second storage unit 23. Since the configuration of the printing apparatus 20 is substantially the same as the configuration of the information processing apparatus 10 described above, the description thereof will be omitted.

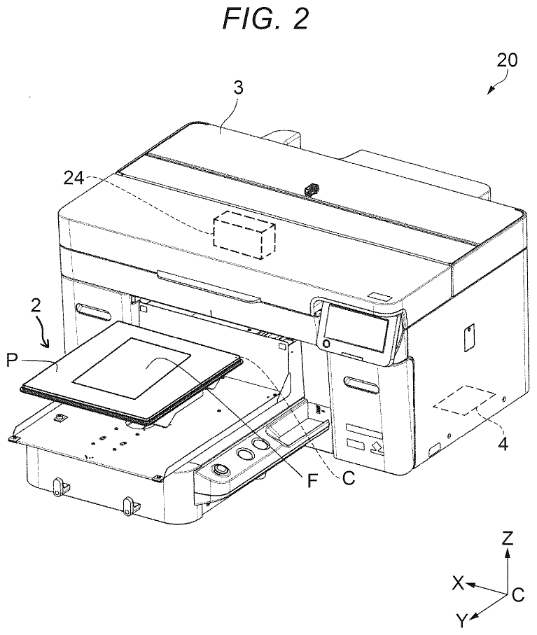

The printing apparatus 20 further includes a printing unit 24. The printing apparatus 20 will be described with reference to FIG. 2. The second control unit 21, the second communication unit 22, and the second storage unit 23 described above are mounted on a control board 4.

The directions in FIG. 2 will be described using a three-dimensional coordinate system with a base point C. For convenience of description, the positive direction of a Z axis is referred to as an upward direction or simply upper, the negative direction is referred to as a downward direction or simply lower, the positive direction of an X axis is referred to as a leftward direction or simply left, the negative direction is referred to as a rightward direction or simply right, the positive direction of a Y axis is referred to as a forward direction or simply front, and the negative direction is referred to as a rearward direction or simply rear. When FIG. 2 is viewed, the left and right sides of the printing apparatus 20 are shown in opposite directions due to the coordinate relationship with other drawings showing a screen S described later.

The printing apparatus 20 is an inkjet printer that can support printing so-called DTF (Direct To Film) and DTG (Direct to Garment).

A main body 3 of the printing apparatus 20 includes the printing unit 24. The printing apparatus 20 prints a print image obtained by processing an image G described later on a target medium F placed on a rectangular platen P by the printing unit 24. Hereinafter, the print image may be referred to as the image G for convenience. Hereinafter, the target medium F is simply referred to as the medium F. In FIG. 2, the mode for printing is set to a DTF mode, and the printing apparatus 20 with the medium F placed on the platen P is illustrated.

The DTG is a printing method related to so-called direct printing of printing the image G on the medium F such as fabric to which the image G is desired to be fixed. On the other hand, the DTF is a printing method related to so-called transfer printing of printing the image G on the medium F which is a transfer medium such as a transfer film.

In the case of the DTF, the printed medium F is hot-pressed to a fabric such as a T-shirt by a separate hot-pressing device, and the image G is transferred.

The printing unit 24 includes a head. The head supports a plurality of colors of ink, and can eject white ink in addition to CMYK (Cyan, Magenta, Yellow, Black) ink. The head can eject ink from above to the medium F placed on the platen P while moving in the left-right direction.

A plurality of platens P having different types and sizes are prepared according to the types of the medium F, images to be printed, and the like. These platens P are detachable from the main body 3 of the printing apparatus 20.

The platen P is movable in the front-rear direction or the like by a moving mechanism 2. The position and attitude of the platen P can be adjusted in any direction with respect to the main body 3.

As described above, the platen P can be replaced with another platen having a different type and size according to the type of the medium F, the image G to be printed, and the like, and the position and the attitude can also be adjusted.

### 2. Print Image Adjustment Method

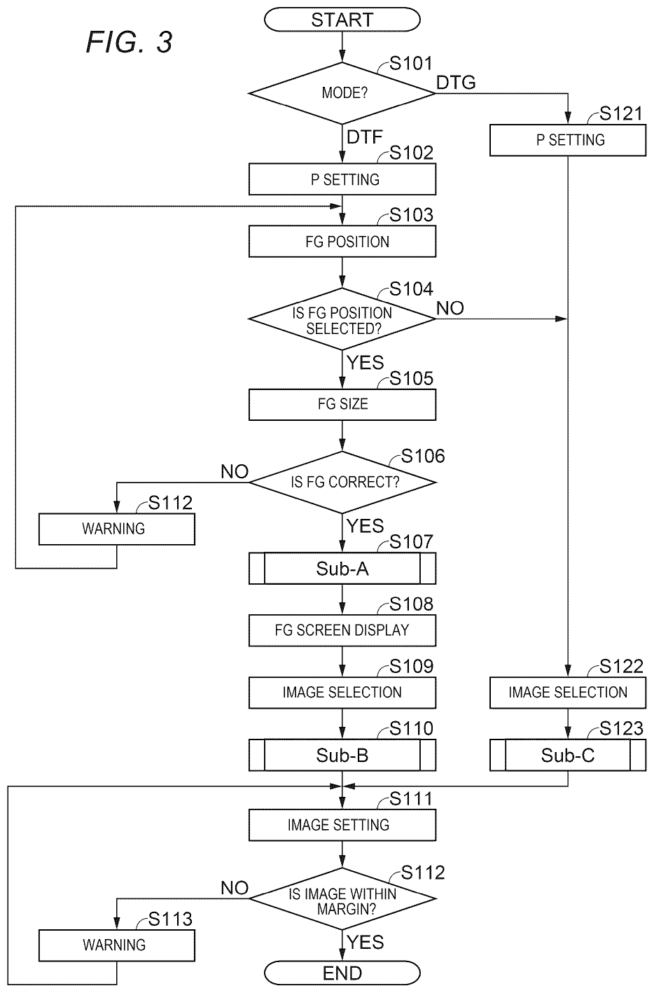

A print image adjustment method for setting the image G to be printed by the information processing apparatus 10 in the printing apparatus 20 will be described with reference to FIGS. 3 to 18.

In order to simplify the description, the information processing apparatus 10 is hereinafter simply referred to as an apparatus 10. In addition, the first control unit 11 of the apparatus 10 reading the program for executing the print image adjustment method stored in the first storage unit 13 and executing each processing will be omitted. Hereinafter, the processing executed by the first control unit 11 of the apparatus 10 is also referred to as a step.

Hereinafter, the image G collectively refers to a first image G1 and the like described later, and the screen S collectively refers to a first screen S1 and the like described later. Further, the apparatus 10 displaying the screen S by the input/output unit 14 and the user making predetermined input through the screen S displayed on the input/output unit 14 will be omitted.

Hereinafter, the setting and the set include a case where the apparatus 10 stores predetermined information in the first storage unit 13 and reads the information. Hereinafter, the apparatus 10 storing the predetermined information related to these settings and sets in the first storage unit 13, reading the predetermined information, and executing each processing will be omitted.

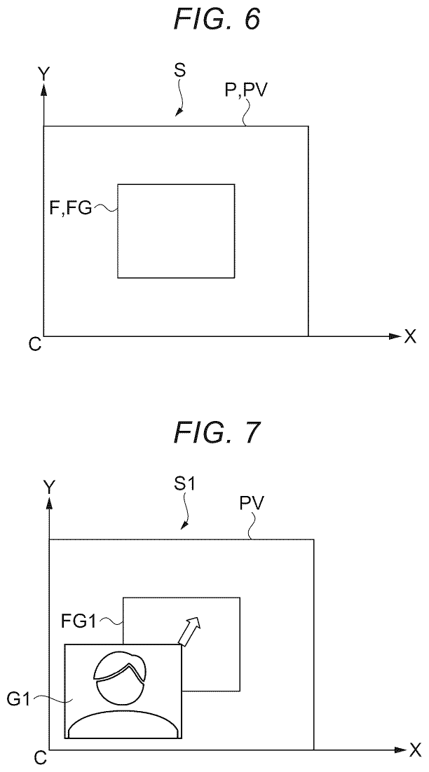

In each of FIG. 6 and the subsequent drawings illustrating the screen S and the like, the coordinates of the X axis and the Y axis with the base point C correspond to the coordinates with the base point C on the platen P of the printing apparatus 20 in FIG. 2.

These coordinates correspond to addresses of the memories including the RAM of the first storage unit 13 of the apparatus 10, and the memories of the first storage unit 13 store the set image G. Furthermore, these coordinates also correspond to addresses of the memories including the RAM of the second storage unit 23 of the printing apparatus 20, and the memories of the second storage unit 23 store the image G to be printed.

In each drawing illustrating the screen S and the like, a virtual platen PV having a position and a size corresponding to the platen P in FIG. 2, which is information set using the above-described coordinates, and a medium guide FG having a position and a size corresponding to the medium F on the platen P in FIG. 2 are displayed.

Therefore, hereinafter, the processing on the platen P by the apparatus 10 can be regarded as processing on the virtual platen PV, and vice versa. Similarly, hereinafter, the processing on the medium F by the apparatus 10 can be regarded as processing on the medium guide FG, and vice versa.

As will be described later, the user can easily set the selected image G by adjusting the position and size of the selected image G while referring to the virtual platen PV and the medium guide FG in the screen S, or the like. The screen S in FIG. 6 or the like on which the user sets the image G while referring to the medium guide FG on the screen S or the like is also referred to as a medium guide FG screen.

As illustrated in FIG. 3, the apparatus 10 starts the processing, and executes a mode selection step as processing (S101) of determining a mode for printing by the printing apparatus 20 based on an instruction of the user to a mode selection screen (not illustrated) displayed on the input/output unit 14. Specifically, the apparatus 10 determines whether the DTF mode as the transfer printing mode or the DTG mode as the direct printing mode is selected. Hereinafter, the DTF mode is also simply referred to as DTF, and the DTG mode is also simply referred to as DTG.

When determining that the DTF is selected (S101: DTF), the apparatus 10 executes setting processing of the platen P (S102). The setting processing (S102) is a printable range setting step of setting the platen P as a printable range. In FIG. 3, for simplicity, the platen P is simply denoted by P, and the medium guide FG is simply denoted by FG. In FIG. 3, the setting processing of the platen P is simply denoted by P setting.

The virtual platen PV, which is an image corresponding to the set platen P, is displayed in each drawing illustrating the screen S and the like, which will be described later.

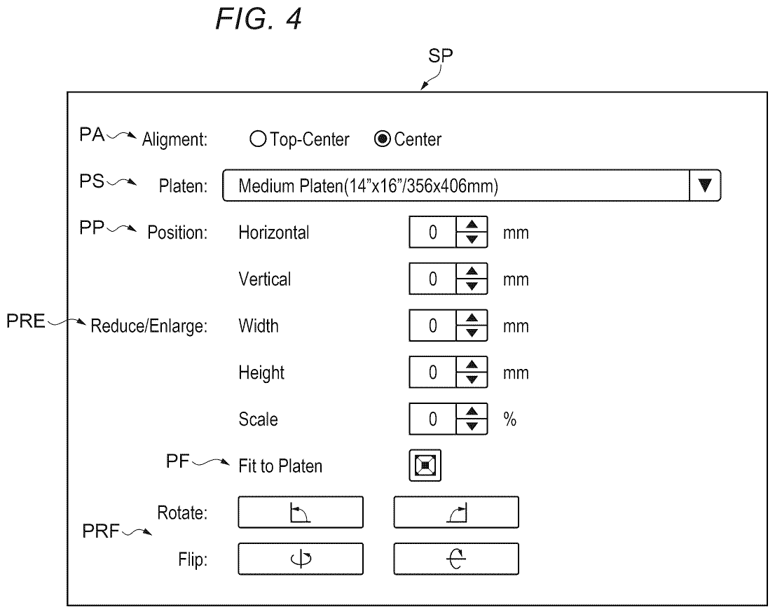

As shown in FIG. 4, the apparatus 10 displays a platen setting screen SP related to the setting of the platen P.

Using the platen setting screen SP, the user can select and input the alignment on the coordinates of the platen P used in the printing apparatus 20 by a platen alignment PA, select and input the standard size by a platen size PS, directly input the position on the coordinates by a platen position PP, and directly input the enlargement/reduction of the size by platen enlarge/reduce PRE. The information of the plurality of standard sizes of the platen P displayed in the platen size PS is stored in the first storage unit 13 of the apparatus 10.

The apparatus 10 can acquire these pieces of information via the platen setting screen SP and make settings related to the platen P (S102).

For example, in the platen alignment PA in FIG. 4, “Top-Center” indicates the forward center position on the coordinates, and “Center” indicates the center position, and the latter is selected in this example. Note that the platen alignment PA may include another position. The information on the plurality of alignments is stored in the first storage unit 13 of the apparatus 10.

In FIG. 4, the apparatus 10 can acquire information indicating that the platen P is to be placed at “Center”, and make settings related to the alignment of the platen P.

The apparatus 10 may display the virtual platen PV corresponding to the platen P to be set together with the platen setting screen SP, or may detect tapping, pinching in, pinching out, and dragging, or the like operated by the user with respect to the virtual platen PV by the input/output unit 14 to set the position, the size, or the like of the platen P.

Further, the apparatus 10 can automatically set the image G in accordance with the position and the size of the platen P as will be described later by the input of the selection of the platen fit button PF by the user on the platen setting screen SP. Furthermore, the apparatus 10 can set the rotation of the platen P by a rotation setting PRF.

The apparatus 10 can also acquire these pieces of information input by the user via the platen setting screen SP and make settings related to the platen P.

Next, the apparatus 10 performs processing (S103) to (S106) illustrated in FIG. 3 as the settings of the medium guide FG corresponding to the medium F. The processing is also referred to as a printable range setting step of setting the medium guide FG corresponding to the medium F as a printable range, which is executed by the apparatus 10.

As described above, the apparatus 10 temporarily executes the printable range setting step of setting the platen P as the printable range, which is the setting processing of the platen P (S102). Then, when the DTF is selected in the mode selection step (S101) (S101: DTF), the apparatus 10 can execute the settings of the medium guide FG (S103) to (S106). The settings of the medium guide FG (S103) to (S106) are the printable range setting step of setting the medium guide FG as the printable range.

As described above, in the printable range setting step as the settings of the medium guide FG (S103) to (S106), the printable range can be changed from the platen P (S102) to the medium guide FG by selecting the DTF in the mode selection step (S101).

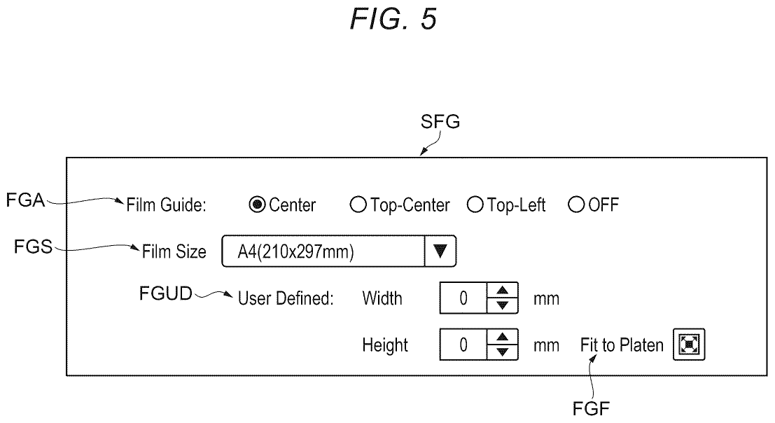

As illustrated in FIG. 5, the apparatus 10 displays a medium guide setting screen SFG of the medium guide FG. The user uses the medium guide setting screen SFG to perform input related to the medium guide FG so as to correspond to the medium F to be placed and printed on the platen P of the printing apparatus 20. On the medium guide setting screen SFG, the user selects and inputs an alignment that is a position on the coordinates of the medium guide FG by the medium guide alignment FGA, and selects and inputs the size of the medium guide FG by the medium guide size FGS.

The apparatus 10 acquires and sets, via the medium guide setting screen SFG, information related to the alignment that is the position on the coordinates of the medium guide FG (S103), and then acquires and sets information related to the size of the medium guide FG (S105). These settings are referred to as settings of the medium guide FG. The settings of the medium guide FG are also the printable range setting step as described above.

The printable range setting step includes processing of setting the medium guide size FGS in accordance with the medium F that is a standard-sized transfer medium having an A4 size or the like. Here, since the medium guide FG corresponds to the standard-sized medium F, the printable range setting step also includes processing of setting in accordance with the medium guide FG by the medium guide size FGS.

In addition, in the setting related to the size of the medium guide FG (S105) described above, the processing of selecting the standard-sized medium F is particularly referred to as a transfer medium selection step of selecting the medium F to be used in the DTF from a plurality of types of standard-sized media F. The information on the plurality of types of standard-sized medium F is stored in the first storage unit 13 of the apparatus 10.

In the medium guide alignment FGA in FIG. 5, “Top-Left” indicates the forward left position on the coordinates, and the rest is the same as in the case of the platen alignment PA in FIG. 4 described above. The information on the plurality of alignments is stored in the first storage unit 13 of the apparatus 10.

In addition to the medium guide alignment FGA, the apparatus 10 can also set the position of the medium guide FG on the detailed coordinates based on user settings FGUD. The user refers to a user of the apparatus.

The processing of selecting and setting the alignment that is the position of the medium guide FG by the medium guide alignment FGA and the processing of setting the detailed position of the medium guide FG based on the user settings FGUD by the apparatus 10 are particularly also referred to as a transfer medium position setting step.

As the transfer medium position setting step, the apparatus 10 can make the setting from a plurality of preset options such as “Center”, “Top-Center”, and “Top-Left” in the medium guide alignment FGA.

As will be described later, the position of the printable range when the DTG is selected can also be referred to as the position of the platen P (S121) set in FIG. 4 described above.

As the above-described transfer medium position setting step, the apparatus 10 can execute processing of setting the position of the medium guide FG as the position of the printable range in the DTF based on the user settings FGUD with respect to the set position of the platen P, which is the position of the printable range in the DTG (S101: DTG).

As a result, when the DTF is selected, the apparatus 10 can display the virtual platen PV at the position corresponding to the platen P and the medium guide FG at the position corresponding to the medium F on the set using the above-described platen P, which are coordinates, as shown in the screen S in FIG. 6.

When the medium guide FG is displayed on the medium guide setting screen SFG, the apparatus 10 may detect tapping, pinching in, pinching out, and dragging, or the like operated by the user on the medium guide FG by the input/output unit 14, and set the position, the size, or the like of the medium guide FG.

Further, the apparatus 10 can automatically set the image G in accordance with the position and size of the medium guide FG as will be described later by the user's input of selection of the fit button FGF on the medium guide setting screen SFG.

The apparatus 10 can also acquire these pieces of information input by the user via the medium guide setting screen SFG and make settings related to the medium guide FG.

Here, in the setting related to the position of the medium guide FG of the medium guide alignment FGA described above (S103), the apparatus 10 determines whether a selection for specifying the position of the medium guide FG such as “Center”, “Top-Center”, or “Top-Left” illustrated in FIG. 5 is input (S104). Note that the medium guide alignment FGA may include another position.

When determining that the selection for specifying the position of any of the medium guides FG is input (S104: YES), the apparatus 10 sets the size of the medium guide FG as described above (S105).

On the other hand, in the setting related to the position of the medium guide FG of the medium guide alignment FGA (S103), when determining that the selection of “OFF” illustrated in FIG. 5 is input and the selection of specifying the position of the medium guide FG is not performed (S104: NO), the apparatus 10 does not perform the subsequent processing related to the medium guide FG. The apparatus 10 performs the so-called exception processing.

That is, as will be described later, the apparatus 10 does not display the medium guide FG as in the case where DTG as a mode not using the medium guide FG is selected (S101: DTG), and proceeds to the next processing (S122).

When the size of the medium guide FG is set as described above (S105), the apparatus 10 compares the set medium guide FG with the set platen P, and determines whether the medium guide FG correctly fits within the range of the platen P (S106).

Specifically, when the medium guide FG of the set size is placed at the set position, the apparatus 10 determines whether the medium guide FG correctly fits within the range of the platen P with respect to the platen P set in the above-described size and alignment.

When determining that the medium guide FG correctly fits within the range of the platen P (S106: YES), the apparatus 10 sets a margin M inside the medium guide FG by “Sub-A”, which is a subroutine, as will be described later (S107). The setting of the margin M can also be referred to as the setting of the medium guide FG.

In order to simplify the description, an example in which the margin M is not set will be described below. The setting of the margin M by “Sub-A” will be described in detail later with reference to FIGS. 15 to 17.

On the other hand, when determining that the medium guide FG does not correctly fit within the range of the platen P (S106: NO), the apparatus 10 gives notification by displaying a warning or the like on the medium guide setting screen SFG illustrated in FIG. 5 (S112).

As will be described later, the printable range when the DTG is selected can also be referred to as the range of the platen P set in FIG. 4 described above (S121).

As described above, in the transfer medium selection step of selecting the medium guide FG in the case of the DTF, when the medium F is selected to protrude from the range of the platen P which is the position of the printable range in the DTG, the apparatus 10 executes a warning notification step of giving notification of a warning (S112).

In this case, since the medium guide FG does not correctly fit within the range of the platen P, even when the apparatus 10 sets the image G in accordance with the medium guide FG, there is a possibility that printing is not actually performed within the range of the medium F on the platen P.

The apparatus 10 returns to the setting related to the position of the medium guide FG (S103) so that the user can correctly set the position and size of the medium guide FG.

When determining that the medium guide FG correctly fits within the range of the platen P (S106: YES), the apparatus 10 executes a display step which is processing of displaying the first screen S1 illustrated in FIG. 7 (S108).

Specifically, as described above, the apparatus 10 displays the virtual platen PV, which is an image corresponding to the platen P (S102) set on the platen setting screen SP, and the first medium guide FG1 set on the medium guide setting screen SFG (S103, S105) as the first screen S1 (S108).

The first screen S1 shown in FIG. 7 is displayed according to the screen S showing the coordinates of the X axis and the Y axis with the base point C shown in FIG. 6. As described above, the first screen S1 displaying the first medium guide FG1 or the like is also referred to as a medium guide FG screen.

As described above, the apparatus 10 stores a plurality of images G in the first storage unit 13, and displays the images on an image selection screen (not illustrated). The apparatus 10 displays the image selection screen and performs processing of selecting the first image G1 to be printed by the user operating the input/output unit 14 (S109).

In the selection processing (S109), the apparatus 10 can execute an image preparation step of reading and preparing the selected first image G1 from the first storage unit 13 and a display step of displaying the read first image G1 on the first screen S1. The display step may include displaying the first screen S1 including the first medium guide FG1 indicating the position of the printable range described above (S108).

As described above, when the DTF is selected in the mode selection step (S101) (S101: DTF), the apparatus 10 can superimpose and display the virtual platen PV corresponding to the platen P and the first medium guide FG1 corresponding to the medium F in the above-described display step as illustrated in the first screen S1 of FIG. 7.

The first medium guide FG1 can display the range and position of the printable range in the DTF.

As will be described later, the position of the printable range when the DTG is selected can also be referred to as the set range and position of the platen P (S121). The virtual platen PV also displays the range and position of the platen P, which is the printable range when DTG as the direct printing mode is selected.

As illustrated in FIG. 7, the user is to set the first image G1 in accordance with the first medium guide FG1 on the first screen S1.

The first screen S1 in FIG. 7 shows the first medium guide FG1 when the position of the medium guide FG is selected as “Center” by the medium guide alignment FGA on the medium guide setting screen SFG in FIG. 5 and the size is selected in accordance with the first image G1 by the medium guide size FGS.

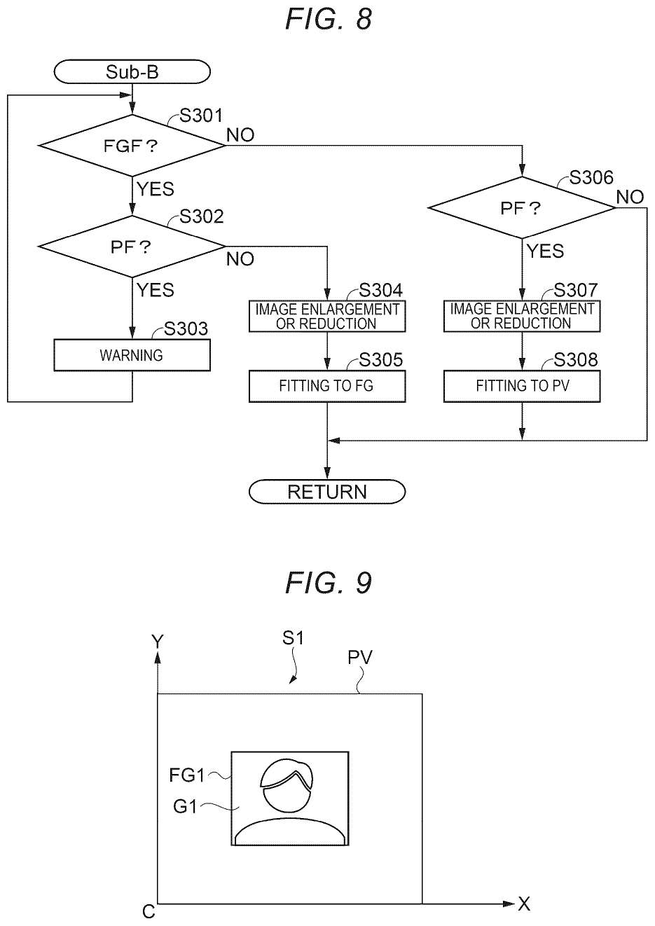

Here, “Sub-B” (S110) as a subroutine executed by the apparatus 10 will be described with reference to FIG. 8. The subroutine “Sub-B” (S110) includes processing when the fit button FGF is selected on the medium guide setting screen SFG in FIG. 5. In FIG. 8, for simplicity, the fit button FGF is simply shown by FGF, the platen fit button PF is simply shown by PF, the medium guide FG is simply shown by FG, and the virtual platen PV is simply shown by PV.

As illustrated in FIG. 8, the apparatus 10 determines whether the fit button FGF on the medium guide setting screen SFG in FIG. 5 is selected (S301). When determining that the fit button FGF is selected (S301: YES), the apparatus 10 then determines whether the platen fit button PF on the platen setting screen SP in FIG. 4 is selected (S302).

Hereinafter, in the apparatus 10, when the fit button FGF and the platen fit button PF are not selected, the user operating the input/output unit 14 to place the image G at the position in the size in accordance with the medium guide FG or the virtual platen PV corresponding to the platen P is referred to as setting.

On the other hand, the apparatus 10 automatically setting the position and size of the image G in accordance with the medium guide FG or the virtual platen PV corresponding to the platen P based on the selection of the fit button FGF or the selection of the platen fit button PF not by the operation of the user is referred to as fitting.

When determining that the platen fit button PF is selected (S302: YES), the apparatus 10 displays a warning indicating that both the fit button FGF and the platen fit button PF are selected on the medium guide setting screen SFG illustrated in FIG. 5 (S303).

In this case, the apparatus 10 cannot determine to which one the image G is fitted. The apparatus 10 returns to the determination as to whether the fit button FGF is selected (S301) so that the user can correctly select one button.

Although not illustrated in FIG. 8, specifically, the apparatus 10 issues the warning (S303), then performs the processing (S102) to (S109) illustrated in FIG. 3 again, and then returns to the determination (S301). The user can correctly make settings on the platen setting screen SP and the medium guide setting screen SFG again.

When determining that the platen fit button PF is not selected (S302: NO), the apparatus 10 can determine that only the fit button FGF is selected. In this case, as illustrated in FIG. 9, the apparatus 10 enlarges or reduces the first image G1 in accordance with the size of the first medium guide FG1 (S304) and fits the first image G1 to the first medium guide FG1 (S305). Note that enlargement/reduction includes enlarging or reducing the image G such as the first image G1, and also includes equal magnification. In this example, the first image G1 is equally magnified.

The first screen S1 illustrated in FIG. 9 is an example in which the position is “Center” as illustrated in FIG. 7 and the first image G1 is equally magnified and fitted to the first medium guide FG1 in the size in accordance with the first image G1.

As described above, the processing of enlarging or reducing the first image G1 (S304) by the apparatus 10 is a step of generating a print image to be printed by the printing apparatus 20 by processing the first image G1 so as to adjust the size and the position, and is also referred to as a print image processing step.

The print image processing step can also include a step of fitting the print image, which is the processed first image G1, within the range of the first medium guide FG1, which is the printable range (S305).

When the first image G1 is fitted to the first medium guide FG1 (S305), the apparatus 10 ends the processing and returns to “Sub-B” (S110) in FIG. 3.

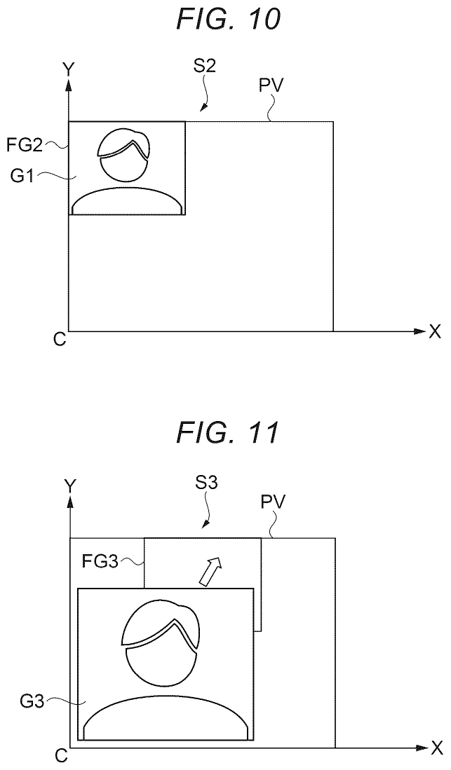

Further, for example, FIG. 10 illustrates a second screen S2 displaying a second medium guide FG2 when the position is selected as “Top-Left” by the medium guide alignment FGA and the size in accordance with the first image G1 is selected by the medium guide size FGS.

In this case, as illustrated by the second screen S2 in FIG. 10, the apparatus 10 enlarges or reduces, in this case, equally magnifies the first image G1 in accordance with the size of the second medium guide FG2 (S304), sets the first image G1 at the position of “Top-Left”, and fits the first image G1 to the second medium guide FG2 (S305).

Here, the user may view the medium guide FG on the screen S and change the setting of the medium guide setting screen SFG in FIG. 5. The apparatus 10 may simultaneously display the screen S and the medium guide setting screen SFG.

It is assumed that the apparatus 10 detects that the setting of the medium guide setting screen SFG is changed. For example, it is assumed that the apparatus 10 detects that the position of the medium guide FG is changed from “Center” to “Top-Left” in the medium guide alignment FGA. In this case, for example, the apparatus 10 can change the display as the setting is changed from the position of “Center” of the first medium guide FG1 illustrated in FIG. 9 to the position of “Top-Left” of the second medium guide FG2 illustrated in FIG. 10.

Here, when there is the first image G1 fitted to the first medium guide FG1, the apparatus 10 can change the first image G1 to fit to the second medium guide FG2. As described above, the apparatus 10 can change and display the fitted first image G1 together with the medium guide FG in accordance with the change of the setting of the medium guide setting screen SFG.

As described above, in the transfer medium position setting step related to the setting of the medium guide setting screen SFG in FIG. 5, the apparatus 10 can also move the print image as the processed first image G1 together with the movement of the position of the second medium guide FG2 as the printable range in the DTF.

Further, for example, FIG. 11 illustrates a third screen S3 displaying a third medium guide FG3 when the position is selected as “Top-Center” by the medium guide alignment FGA and the same size as that in FIG. 7 is selected by the medium guide size FGS. The apparatus 10 is to fit the selected third image G3 to the third medium guide FG3.

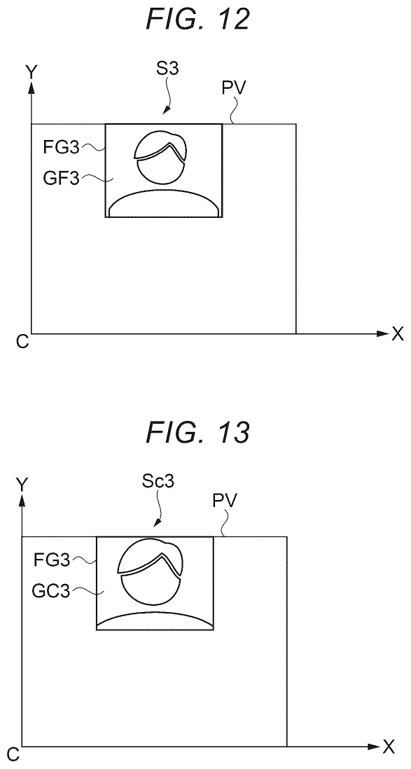

Here, it is assumed that the third image G3 is larger in size than the third medium guide FG3. In this case, as shown by the third screen S3 in FIG. 12, in the print image processing step, the apparatus 10 reduces the third image G3 in accordance with the size of the third medium guide FG3 (S304) to form a third fit image GF3.

The apparatus 10 sets the reduced third fit image GF3 at the position of “Top-Center” and fits the third fit image GF3 in accordance with the third medium guide FG3 (S305). As illustrated in FIG. 12, the third fit image GF3 fits in the third medium guide FG3.

Further, for example, when the third image G3 is larger in size than the third medium guide FG3, the apparatus 10 can cut a portion protruding from the size of the third medium guide FG3 as illustrated in a third correction screen Sc3 in FIG. 13.

Specifically, in the print image processing step, the apparatus 10 cuts the third image G3 of the portion protruding from the size of the third medium guide FG3 (S304) to obtain a third cut image GC3, and fits the third cut image GC3 in accordance with the third medium guide FG3 at the position of “Top-Center” (S305). As illustrated in FIG. 13, the third cut image GC3 fits in the third medium guide FG3.

As described above, in the print image processing step, the apparatus 10 can cut and delete the portion of the third image G3 protruding from the third medium guide FG3 as a printable range.

When the third image G3 is larger in size than the third medium guide FG3, whether to reduce the third image G3 as illustrated in FIG. 12 or cut the third image G3 as illustrated in FIG. 13 may be selected by the user by providing an item to be selected on the medium guide setting screen SFG displayed by the apparatus 10.

In the determination of the selection of the fit button FGF described above (S301), when determining that the fit button FGF is not selected (S301: NO), the apparatus 10 then determines whether the platen fit button PF on the platen setting screen SP in FIG. 4 is selected (S306).

Here, for example, it is assumed that the first image G1 as illustrated in FIG. 7 is selected. It is assumed that the first image G1 is smaller in size than the virtual platen PV corresponding to the platen P.

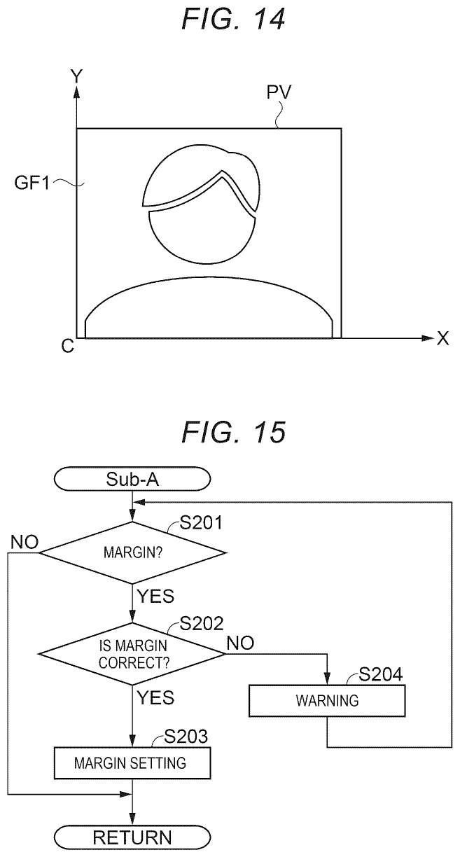

When determining that the platen fit button PF is selected (S306: YES), as illustrated in FIG. 14, the apparatus 10 enlarges the first image G1 in accordance with the size of the virtual platen PV (S307) to obtain a first fit image GF1. The apparatus 10 can reduce or equally magnifies the first image G1 depending on the size of the first image G1 with respect to the virtual platen PV.

The apparatus 10 fits the enlarged first fit image GF1 in accordance with the virtual platen PV (S308). As illustrated in FIG. 14, the first fit image GF1 fits in the virtual platen PV. In this case, since it is unnecessary for the user to perform any operation, the apparatus 10 does not necessarily display the screen as illustrated in FIG. 14.

On the other hand, when determining that the platen fit button PF is not selected (S306: NO), the apparatus 10 ends the processing.

When the processing related to “Sub-B” illustrated in FIG. 8 ends, the apparatus 10 returns to “Sub-B” (S110) in FIG. 3.

When the platen fit button PF on the platen setting screen SP in FIG. 4 is selected, or when the fit button FGF on the medium guide setting screen SFG in FIG. 5 is selected, the apparatus 10 performs processing as in “Sub-B” illustrated in FIG. 8 described above. That is, the apparatus 10 fits the selected image G in accordance with the position and size of the virtual platen PV or the medium guide FG.

The image G fitted in this manner can be assumed to be already set on the virtual platen PV or the medium guide FG. It can be said that the apparatus 10 automatically sets the selected image G in accordance with the position and size of the virtual platen PV or each medium guide FG. Therefore, the apparatus 10 proceeds to the next processing without performing the setting processing (S111).

On the other hand, when the platen fit button PF or the fit button FGF is not selected, the image G is not set yet. It is necessary for the user to set the image G in accordance with the virtual platen PV or the medium guide FG. The apparatus 10 can manually set the selected image G based on the user's operation in accordance with the position and size of the virtual platen PV or each medium guide FG.

For example, as illustrated in FIG. 7, the apparatus 10 displays the first medium guide FG1 and the first image G1 selected by the user on the first screen S1.

The user performs operations such as tapping, pinching in, pinching out, and dragging on the first image G1 on the first screen S1 using the input/output unit 14. By these operations, the first image G1 can be moved in position, enlarged or reduced in size, and set in accordance with the virtual platen PV or the first medium guide FG1.

Note that, in the apparatus 10, the position and size of the first image G1 may be input in numbers on a setting screen (not illustrated) for instruction on the position and size of the first image G1 so that the first image G1 can be set in accordance with the first medium guide FG1.

The apparatus 10 can detect these user operations on the first image G1 by the input/output unit 14, move the position of the first image G1 on the first screen S1, enlarge or reduce the size, and set the first image G1 in accordance with the virtual platen PV or the first medium guide FG1 (S111).

Further, the apparatus 10 can detect the user operations of by the input/output unit 14, move the position of each image G on each screen S, enlarge or reduce the size, and set the image in accordance with the virtual platen PV or the medium guide FG, as described above with reference to FIGS. 9 to 14 (S111).

Here, the setting of the margin M by the above-described subroutine “Sub-A” (S107) executed by the apparatus 10 will be described in detail with reference to FIGS. 15 to 17.

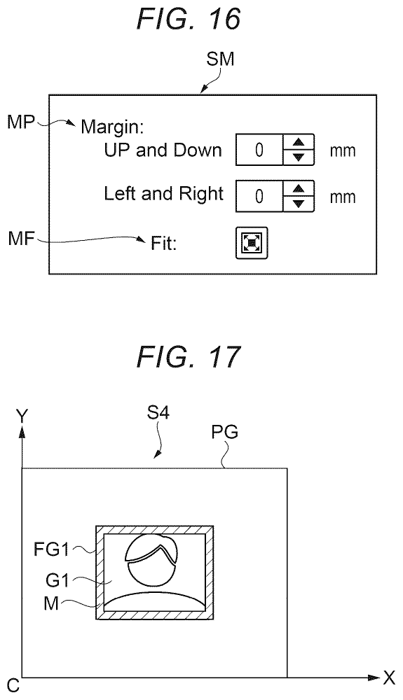

The apparatus 10 displays a margin setting screen SM of the medium guide FG in FIG. 16, acquires the upper and lower length of the margin M and the left and right length of the margin M of the medium guide FG by margin lengths MP based on the input by the user, and sets the margin M. As illustrated in FIG. 17, the margin M is set in a frame shape inside the first medium guide FG1 as the medium guide FG.

As described above, the medium guide FG corresponds to the medium F. The margin M of the medium guide FG is provided in order to secure a region of the medium F on which printing is actually performed, such as a region gripped by the user's hand or a region where a tape is applied. Therefore, the margin M is an area that is not printed and is also referred to as an unprintable area.

As illustrated in FIG. 15, the apparatus 10 determines whether the margin M is input for the margin lengths MP on the margin setting screen SM in FIG. 16 (S201).

When determining that the margin M is input (S201: YES), the apparatus 10 determines whether the value of the input margin M is correct (S202). For example, in a case where the input value of the margin M is within the range of the medium guide FG, when determining that the value of the margin M is correct (S202: YES), the apparatus 10 sets the margin M (S203).

On the other hand, in a case where the input value of the margin M exceeds the range of the medium guide FG or the like, the apparatus 10 determines that the value of the margin M is not correct (S202: NO), gives notification by displaying a warning or the like on the margin setting screen SM (S204), and returns to the determination of the input of the margin M (S201).

The user can correctly set the margin M again by the margin setting screen SM in FIG. 16.

Here, by selecting the margin fit button MF on the margin setting screen SM, the apparatus 10 can move the position of the image G in accordance with the inside of the margin M set for the medium guide FG, enlarge or reduce the size, and automatically fit the image G.

In this case, the apparatus 10 can reflect the fitting on the processing when the fit button FGF is selected and the platen fit button PF is not selected (S302: NO) illustrated in FIG. 8 in “Sub-B” (S110) in FIG. 3 described above. This will be described in detail below.

A fourth screen S4 illustrated in FIG. 17 is an example in which the position is “Center” as illustrated in FIG. 7, and the first image G1 is equally magnified and fitted inside the set margin M in accordance with the first medium guide FG1 in which the margin M is set on the margin setting screen SM of FIG. 14.

That is, in the processing when the fit button FGF is selected and the platen fit button PF is not selected (S302: NO) illustrated in FIG. 8, the apparatus 10 can automatically enlarge or reduce the first image G1 (S304) and fit the first image G1 to the inside of the margin M of the first medium guide FG1 (S305) for which the margin M is set by selecting the margin fit button MF. In FIG. 17, the enlargement or reduction of the first image G1 is equal magnification. When the first image G1 is larger, the apparatus 10 may cut the first image G1 in accordance with the inside of the margin M of the first medium guide FG1.

When the margin fit button MF is selected, the apparatus 10 may perform processing in preference to the fit button FGF illustrated in FIG. 5. Specifically, when the margin fit button MF is selected, the apparatus 10 can perform processing on the assumption that the fit button FGF illustrated in FIG. 8 is already selected and the platen fit button PF is not selected (S302: NO).

When the first image G1 is fitted to the first medium guide FG1 for which the margin M is set (S305), the apparatus 10 ends the processing of “Sub-B” illustrated in FIG. 8 and returns to “Sub-B” (S110) in FIG. 3 in the same manner as described above.

It is assumed that each image G fitted to the medium guide FG for which the margin M is set in the medium guide FG for which the margin M is set. Hereinafter, the medium guide FG for which the margin M is set is referred to as a margin set medium guide MFG.

On the other hand, when the margin fit button MF is not selected, the image G is not set in the margin set medium guide MFG yet. It is necessary for the user to manually set the image G in accordance with the margin set medium guide MFG.

For example, on the fourth screen S4 in FIG. 17, the user performs operations such as tapping, pinching in, pinching out, and dragging on the first image G1 using the input/output unit 14. By these operations, the first image G1 can be moved in position, enlarged or reduced in size, and set in accordance with the first medium guide FG1 as the margin set medium guide MFG. Here, the margin set medium guide MFG is the first medium guide FG1 for which the margin M is set.

Note that, in the apparatus 10, the position and size of the first image G1 may be input in numbers on a setting screen (not illustrated) for instruction on the position and size of the first image G1 so that the first image G1 can be set in accordance with the margin set medium guide MFG.

The apparatus 10 can detect these user operations on the first image G1 by the input/output unit 14, move the position with respect to the first image G1 on the fourth screen S4, enlarge or reduce the size, and set the first image G1 in accordance with the margin set medium guide MFG (S111).

The apparatus 10 determines whether the set first image G1 fits inside the margin M within the margin M of the first medium guide FG1 as the margin set medium guide MFG (S112).

When determining that the set first image G1 fits inside the margin M of the first medium guide FG1 (S112: YES), the apparatus 10 ends the processing. Even when the margin M is not set, the apparatus 10 determines that the image fits inside the margin M.

Meanwhile, as described above, the coordinates in each of FIG. 6 and the subsequent drawings illustrating the screen S and the like correspond to the position of the coordinates on the platen P of the printing apparatus 20 with the base point C illustrated in FIG. 2, and further correspond to the addresses in the memories of the first storage unit 13 of the apparatus 10 and the addresses in the memories of the second storage unit 23 of the printing apparatus 20.

On the other hand, the apparatus 10 displays the virtual platen PV and the medium guide FG in FIG. 6 and the subsequent drawings illustrating the screen S and the like in accordance with the platen P and the medium F of the printing apparatus 20 based on the input by the user, and sets the image G in accordance with the medium guide FG.

Therefore, the apparatus 10 can store the position of the set image G in association with the address in the memory of the first storage unit 13. After ending the processing illustrated in FIG. 3, the apparatus 10 may sequentially read the images G from the addresses in the memory of the first storage unit 13 and transmit the images G to the printing apparatus 20, including the cases described later.

The printing apparatus 20 can sequentially store the received images G at the addresses in the memory of the second storage unit 23 corresponding to the positions thereof. By sequentially reading the images G from the addresses in the memory of the second storage unit 23 and printing the images G by the printing unit 24, the printing apparatus 20 can perform printing on the medium F on the platen P as set by the apparatus 10.

The apparatus 10 may acquire information related to the position of the image G set on the screen S and transmit the information to the printing apparatus 20 together with the image G. The printing apparatus 20 may specify the position of the image G based on the received information related to the position and perform printing on the medium F.

Referring back to FIG. 3, the description is continued. The apparatus 10 determines the margin M as described above (S112: YES) in FIG. 3, and ends the processing.

Then, the apparatus 10 transmits the first image G1 set in the manner described above to the printing apparatus 20. The printing apparatus 20 can print the received first image G1 on the medium F on the platen P within the set margin M at the set position and size.

On the other hand, when determining that the set first image G1 does not fit within the margin M of the first medium guide FG1 (S112: NO), the apparatus 10 gives notification of a warning thereof on the fourth screen S4 in FIG. 17 (S113).

In this case, the first image G1 does not fit inside the margin M of the first medium guide FG1 and overlaps the margin M, and the necessary margin M may not be secured.

The apparatus 10 returns to the setting of the first image G1 (S111) so that the user can correctly set the first image G1 inside the margin M of the first medium guide FG1.

When the first image G1 overlaps the margin M, a portion of the first image G1 overlapping the margin M may be processed not to be printed by the printing apparatus 20.

Here, the description will be continued by returning to the mode determination (S101) illustrated in FIG. 3. When determining that the DTG is selected (S101: DTG), the apparatus 10 sets the platen P (S121). When the DTG is selected, the apparatus 10 executes the printable range setting step of setting the platen P as the printable range.

When the DTG is selected, the apparatus 10 does not perform the printable range setting step based on the setting of the medium guide FG performed when the DTF is selected. The range and position of the printable range when the DTG is selected can also be referred to as the set range and position of the platen P (S121). The range and position of the platen P are also the range and position of the virtual platen PV corresponding to the platen P.

The apparatus 10 does not display the medium guide FG on the screen S as illustrated in FIG. 6, for example, in the subsequent processing including the processing in (S121). This is because the apparatus 10 does not use the medium F in the DTG and thus does not need to display the medium guide FG.

Since the setting of the platen P (S121) here is the same as the case of the setting of the platen P (S102) when the DTF is selected as described above, the description thereof will be omitted.

Then, the apparatus 10 selects the image G to be printed (S122). Since the selection of the image G (S122) here is the same as the selection of the image G (S109) when the DTF is selected as described above, the description thereof will be omitted.

Here, the apparatus 10 executes “Sub-C” (S123) as a subroutine.

As described above, when determining that “OFF” is selected in the medium guide alignment FGA of the medium guide setting screen SFG illustrated in FIG. 5 and the selection for specifying the position of the medium guide FG is not made (S104: NO), the apparatus 10 does not display the medium guide FG and proceeds to processing of “Sub-C” (S123). In this case, the apparatus 10 has already set the platen P (S102).

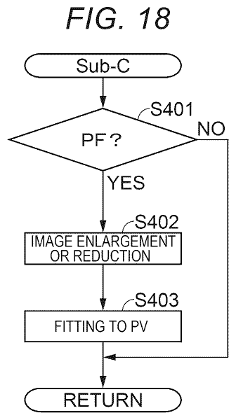

The processing in (S401) to (S403) of “Sub-C” illustrated in FIG. 18 is the same as the processing (S306) to (S308) of “Sub-B” illustrated in FIG. 8.

That is, when determining that the platen fit button PF on the platen setting screen SP in FIG. 4 is selected (S401: YES), the apparatus 10 enlarges or reduces the selected image G (S402), sets the image as a fit image GF (not shown), and fits the image to the virtual platen PV (S403).

On the other hand, when determining that the platen fit button PF is not selected (S401: NO), the apparatus 10 ends the processing.

When the processing related to the above-described “Sub-C” illustrated in FIG. 18 ends, the apparatus 10 returns to “Sub-C” (S123) in FIG. 3 and proceeds to the processing of setting the image G (S111).

As described above, when the platen fit button PF is selected, it can be assumed that the selected image G is fitted to the virtual platen PV and set. The apparatus 10 proceeds to the next processing without performing the setting processing (S111).

On the other hand, when the platen fit button PF is not selected, the image G is not set yet. As described above, the apparatus 10 sets the image G in accordance with the virtual platen PV (S111).

Then, the apparatus 10 determines whether the set image G fits within the margin M (S112). Here, since the apparatus 10 does not perform the processing of the subroutine “Sub-A” (S107) of setting the margin M, the margin M is not set.

As described above, as in the case where the margin M is not set, the apparatus 10 determines that the image fits inside the margin M (S112: YES), and ends the processing.

As described above, the print image adjustment method executed by the apparatus 10 includes the printable range setting step of setting the printable range, the image preparation step of preparing the image G, the display step of displaying the position of the printable range and the image G, and the print image processing step of processing the image G to generate the print image. In the print image processing step, the image G is processed so that the print image fits within the printable range.

For example, when the printable range is set to the medium guide FG corresponding to the medium F, the user can easily set the selected image G on the medium guide FG by adjusting the position and size of the selected image G while referring to the medium guide FG on the screen S as the printable range.

When the fit button FGF on the medium guide setting screen SFG in FIG. 5 is selected, the apparatus 10 can automatically set the selected image G by adjusting the position and size of the medium guide FG.

Although the embodiments have been described in detail with reference to the drawings, the specific configurations are not limited to the embodiments, and may be changed, replaced, or deleted without departing from the gist of the disclosure.

What is claimed is:

1. A print image adjustment method comprising:
a printable range setting step of setting a printable range;
an image preparation step of preparing an image;
a display step of displaying a position of the printable range and the image; and
a print image processing step of processing the image to generate a print image, wherein
the print image processing step includes processing the image to fit the print image within the printable range.

2. The print image adjustment method according to claim 1, wherein
the print image processing step includes reducing or enlarging the image.

3. The print image adjustment method according to claim 1, wherein
the print image processing step includes deleting a portion of the image protruding from the printable range.

4. The print image adjustment method according to claim 1, comprising a mode selection step of selecting a direct printing mode in which the print image is printed on a target medium to which the printed image is desired to be fixed or a transfer printing mode in which the print image is printed on a transfer medium, wherein
the printable range setting step includes changing the printable range by the selection in the mode selection step.

5. The print image adjustment method according to claim 4, wherein
the display step includes, when the transfer printing mode is selected in the mode selection step, superimposing and displaying a position of the printable range in the direct printing mode and a position of the printable range in the transfer printing mode.

6. The print image adjustment method according to claim 5, comprising a transfer medium position setting step of setting the position of the printable range in the transfer printing mode with respect to the position of the printable range in the direct printing mode in the transfer printing mode.

7. The print image adjustment method according to claim 6, wherein
the transfer medium position setting step includes setting the position from a plurality of preset options.

8. The print image adjustment method according to claim 6, wherein
the transfer medium position setting step includes moving the print image along with movement of the position of the printable range in the transfer printing mode.

9. The print image adjustment method according to claim 4, wherein
the printable range setting step includes, when the transfer printing mode is selected in the mode selection step, setting the printable range in accordance with the transfer medium having a standard size.

10. The print image adjustment method according to claim 8, comprising a transfer medium selection step of selecting the transfer medium to be used in the transfer printing mode from a plurality of types of the standard-sized transfer media.

11. The print image adjustment method according to claim 10, comprising a warning notification step of giving notification of a warning when the transfer medium that protrudes from the printable range in the direct printing mode is selected in the transfer medium selection step.
